(19) United States
(12) Patent Application Publication
(10) Pub. No.: US 2025/0187024 A1
(43) Pub. Date: Jun. 12, 2025

(54) ELECTROSTATIC SPRAYING DEVICE AND CARTRIDGE FOR ELECTROSTATIC SPRAYING DEVICE

(71) Applicant: KAO CORPORATION, Tokyo (JP)

(72) Inventors: Hirokatsu SUGAWARA, Tokyo (JP); Ryo KOBAYASHI, Tokyo (JP); Kimie SANNOMIYA, Tokyo (JP)

(73) Assignee: KAO CORPORATION, Tokyo (JP)

(21) Appl. No.: 18/845,579

(22) PCT Filed: Mar. 9, 2023
(86) PCT No.: PCT/JP2023/009123

§ 371 Date: Sep. 10, 2024

(30) Foreign Application Priority Data
Mar. 11, 2022 (JP) 2022-038307

(51) Int. Cl. B05B 5/035; B05B 5/053; B05B 5/16

(52) U.S. Cl. CPC B05B 5/035; B05B 5/0533; B05B 5/1691

(57) ABSTRACT

An electrostatic spraying device includes a spray unit that sprays a liquid. The spray unit includes a nozzle for spraying the liquid, a flow path for distributing the liquid to a spray hole provided at a nozzle tip portion, and a shut-off pin configured to advance and retract in the flow path and configured to seal the spray hole. The shut-off pin has a tip portion that is unexposed from the spray hole in a state where the spray hole is sealed.

### FIELD

The present invention relates to an electrostatic spraying device and a cartridge for electrostatic spraying device.

### BACKGROUND

Conventionally, there has been known an electrostatic spraying device that sprays a liquid by an electrostatic force. For example, Patent Literature 1 discloses an electrostatic spraying device that includes a motor, a high-voltage generator, a battery, and the like inside the electrostatic spraying device and sprays a liquid composition, which is electrostatically charged by a high voltage from the high-voltage generator, toward an object from a nozzle. Patent Literatures 2 and 3 disclose electrostatic spraying devices provided with needle valves and rods to close spray holes of nozzles.

### CITATION LIST

### Patent Literature

Patent Literature 1: Japanese Unexamined Patent Application Publication No. 2020-195957
Patent Literature 2: Japanese Unexamined Patent Application Publication No. 2005-288212
Patent Literature 3: Japanese Unexamined Patent Application Publication No. 2016-144786

### SUMMARY OF INVENTION

### Technical Problem

In the electrostatic spraying device of Patent Literature 1, since the spray hole of the nozzle is closed with a cap, there has been a problem that situations of dripping and the liquid composition sticking in the nozzle cannot be avoided if the cap is forgotten to be closed. On the other hand, in the electrostatic spraying devices of Patent Literature 2 and Patent Literature 3, there has been a problem that, while the needle valves and the rods are provided to close nozzle tips, they are not physically or electrically safe because the needle valves and the rods are exposed from the spray holes of the nozzles.

The present invention relates to an electrostatic spraying device and a cartridge for electrostatic spraying device that can be used safely when in use and can ensure that a spray hole of a nozzle is sealed when not in use.

### Solution to Problem

An electrostatic spraying device according to the present invention is an electrostatic spraying device including a spray unit that sprays a liquid. The spray unit includes a nozzle for spraying the liquid, a flow path for distributing the liquid to a spray hole provided at a nozzle tip portion, and a shut-off pin configured to advance and retract in the flow path and configured to seal the spray hole. The shut-off pin has a tip portion that is unexposed from the spray hole in a state where the spray hole is sealed.

A cartridge for electrostatic spraying device according to the present invention is a cartridge for electrostatic spraying device including a spray unit that sprays a liquid. The spray unit includes a nozzle for spraying the liquid, a flow path for distributing the liquid to a spray hole provided at a nozzle tip portion, and a shut-off pin configured to advance and retract in the flow path and configured to seal the spray hole. The shut-off pin has a tip portion that is unexposed from the spray hole in a state where the spray hole is sealed.

### Advantageous Effects of Invention

The electrostatic spraying device and the cartridge for electrostatic spraying device of the present invention can be used safely when in use and can ensure that a spray hole of a nozzle is sealed when not in use.

### BRIEF DESCRIPTION OF DRAWINGS

FIG. 1 is a perspective view illustrating an electrostatic spraying device according to an embodiment.

FIG. 2 is an exploded perspective view illustrating a state in which a cartridge according to the embodiment is removed from an electrostatic spraying main body.

FIG. 3 is a left side cross-sectional side view illustrating the electrostatic spraying device according to the embodiment.

FIG. 4 is a partially enlarged cross-sectional view illustrating the enlargement of a part of the cartridge according to the embodiment.

FIG. 5 is a partially enlarged cross-sectional view illustrating the enlargement of a nozzle tip portion and a tip portion of a shut-off pin according to the embodiment.

FIG. 6 is a block configuration diagram illustrating a configuration included in a housing of the electrostatic spraying device according to the embodiment.

FIG. 7 is a partially enlarged cross-sectional view illustrating a modification of the nozzle tip portion and the tip portion of the shut-off pin according to the embodiment.

### DETAILED DESCRIPTION

Hereinafter, a preferred embodiment for carrying out the present invention will be described by referring to the drawings. Note that, the following embodiment does not limit the present invention according to each of the claims, and all combinations of the characteristics described in the embodiment are not necessarily essential for means for solving the problems of the present invention. In addition, in the embodiment, the scale and dimensions of each component may be exaggerated, or some components may be omitted.

### [Overall Configuration and Operational Action of Electrostatic Spraying Device]

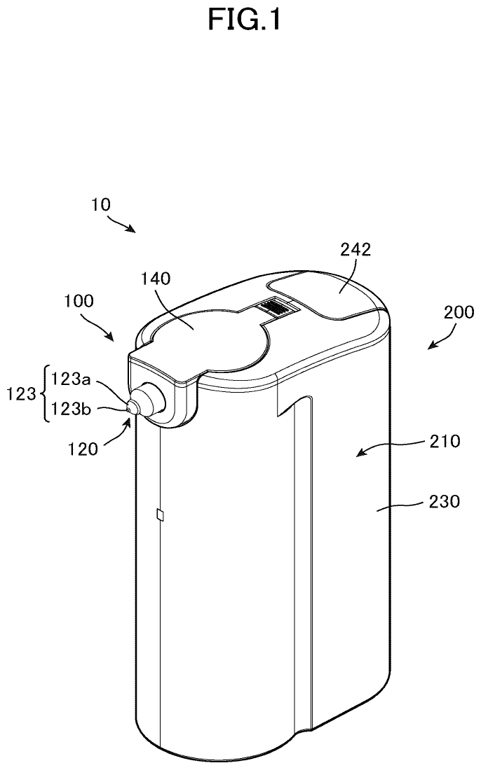

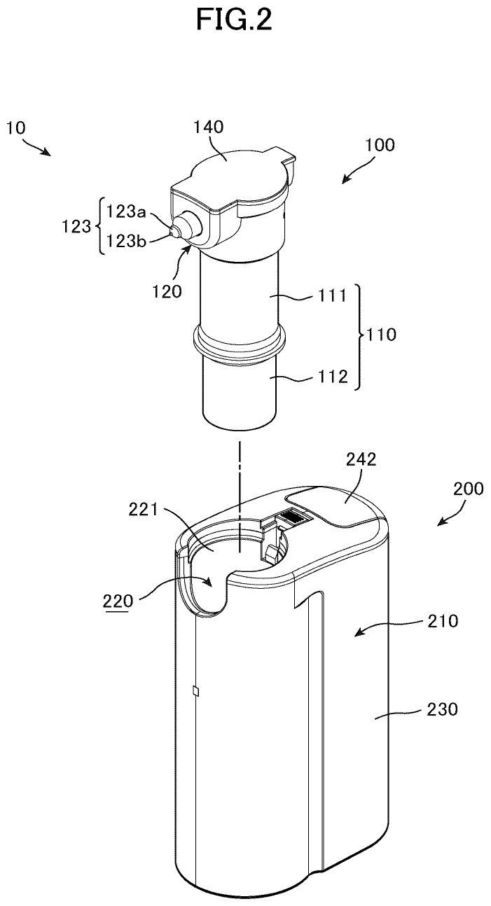

An electrostatic spraying device 10 according to the embodiment includes, as illustrated in FIG. 1 and FIG. 2, a cartridge for electrostatic spraying device 100 (hereinafter, simply referred to as a cartridge 100) that contains a liquid, and an electrostatic spraying main body 200 into and from which the cartridge 100 is insertable and removable. In the embodiment below, for the convenience of explanation, a direction in which the cartridge 100 is inserted into the electrostatic spraying main body 200 is defined as a lower side, and a direction in which the cartridge 100 is removed from the electrostatic spraying main body 200 is defined as an upper side to give an explanation. However, the up-down direction mentioned here is not necessarily the up-down direction in the actual usage condition.

The electrostatic spraying device 10 according to the embodiment is a hand-held type device which has a shape and a size that can be gripped by a user with a hand, and sprays a liquid composition (the liquid) toward an object by an electrostatic spray method. The electrostatic spray method is a method in which a high voltage (for example, several kV to several dozen kV) is applied to a liquid composition (for example, a solution in which a high-molecular compound is dissolved in a volatile solvent) such that the liquid composition is electrostatically charged, and the liquid composition is sprayed toward an object by an electrostatic force based on a potential difference between the electrically charged liquid composition and the object. The liquid composition sprayed by the electrostatic spray method is sent toward the object in a mist form or an ultrafine thread form. In the sprayed liquid composition, the solvent that is a volatile substance is dried while the liquid composition is sprayed and then, is sent toward the object and after the liquid composition is attached to the object, and thus, a film can be formed on a surface of the object. Note that the electrostatic spraying device 10 according to the embodiment can also be used as an electrostatic spinning device spraying a solution containing a raw material for electrostatic spinning, that is, a spinning liquid toward the object.

For example, in a case where a solution containing a volatile substance, a water-insoluble polymer for forming a fiber, and water is adopted as the liquid composition, the user grips the electrostatic spraying device 10 with the hand and sprays the liquid composition toward the skin of the user, thereby allowing a film to be formed on the surface of the skin of the user. The film is preferably a deposit containing a fiber.

Specifically, as the liquid composition or the spinning liquid used in an electrostatic spraying device or an electrostatic spinning device, for example, a solution in which a high-molecular compound configured to form a film, more preferably a high-molecular compound configured to form a fiber is dissolved in a solvent can be used. Any of a water-soluble high-molecular compound or a water-insoluble high-molecular compound can be used as the high-molecular compound. The high-molecular compound configured to form a fiber preferably contains a water-insoluble high-molecular compound.

When the water-insoluble high-molecular compound is used, the liquid composition contains 50 mass % or more volatile liquid agent selected from an alcohol and a ketone. The volatile liquid agent is a substance having volatility in a liquid state. A vapor pressure of the volatile liquid agent at 20° C. is preferably 0.01 kPa or more and 106.66 kPa or less, more preferably 0.13 kPa or more and 66.66 kPa or less, further preferably 0.67 kPa or more and 40.00 kPa or less, and even more preferably 1.33 kPa or more and 40.00 kPa or less.

Among the volatile liquid agents, for example, a monovalent chain aliphatic alcohol, a monovalent cyclic aliphatic alcohol, and a monovalent aromatic alcohol are preferably used as the alcohol. Examples of the monovalent chain aliphatic alcohol include C₁-C₆ alcohol, examples of the monovalent cyclic alcohol include C₄-C₆ cyclic alcohol, and examples of the monovalent aromatic alcohol include benzyl alcohol, and phenylethyl alcohol. Specific examples thereof include ethanol, isopropyl alcohol, butyl alcohol, phenylethyl alcohol, n-propanol, and n-pentanol. One kind or two or more kinds selected from the alcohols can be used.

Among the volatile liquid agents, examples of the ketone include di-C₁-C₄ alkyl ketone, such as acetone, methyl ethyl ketone, and methyl isobutyl ketone. One kind of the ketones can be used alone, or two or more kinds of the ketones can be used in combination.

The volatile liquid agent is a volatile liquid agent more preferably containing one kind or two or more kinds selected from ethanol, isopropyl alcohol, and butyl alcohol, even more preferably containing one kind or two kinds selected from ethanol and butyl alcohol, and further preferably containing ethanol from the aspect of the touch of a fiber to be formed. An amount of the above-described volatile liquid agent contained is preferably 85 mass % or more, preferably 90 mass % or more, and preferably 100 mass % or less in the volatile liquid agent.

The contained amount of the volatile liquid agent in the liquid composition is preferably 50 mass % or more, more preferably 55 mass % or more, and further preferably 60 mass % or more. In addition, the contained amount is preferably 95 mass % or less, more preferably 94 mass % or less, and further preferably 93 mass % or less. The contained amount of the volatile liquid agent in the liquid composition is preferably 50 mass % or more and 95 mass % or less, more preferably 55 mass % or more and 94 mass % or less, and further preferably 60 mass % or more and 93 mass % or less. By containing the volatile liquid agent in the liquid composition at this proportion, the liquid composition can be sufficiently volatilized when the electrostatic spray method is performed, and a film containing a fiber can be formed on the surface of the skin or nail.

The ethanol is preferably 50 mass % or more, further preferably 65 mass % or more, and even more preferably 80 mass % or more, with respect to the total amount of the volatile liquid agent, from the aspect of high volatility and the touch of the fiber to be formed. In addition, the ethanol is preferably 100 mass % or less. The ethanol is preferably 50 mass % or more and 100 mass % or less, further preferably 65 mass % or more and 100 mass % or less, and even more preferably 80 mass % or more and 100 mass % or less, with respect to the total amount of the volatile liquid agent.

The liquid composition preferably contains a water-insoluble polymer for forming a fiber. The water-insoluble polymer for forming a fiber is a substance that can be dissolved in the volatile liquid agent. Here, dissolving means being in a dispersed state at 20° C. and the dispersed state being a visually homogeneous state, preferably, a visually transparent or semi-transparent state.

The water-insoluble polymer for forming a fiber is a polymer that is soluble in a volatile substance and insoluble in water. In the specification, a “water-soluble polymer” refers to a polymer having a property in which, after 1 g of the polymer is weighted and then dipped in 10 g of ion exchanged water in an environment of one atmosphere and 23° C., 0.5 g or more of the dipped polymer is dissolved in water after a lapse of 24 hours. On the other hand, in the specification, a “water-insoluble polymer” refers to a polymer having a property in which, after 1 g of the polymer is weighed and then dipped in 10 g of ion exchanged water in an environment of one atmosphere and 23° C., 0.5 g or more of the dipped polymer is not dissolved after a lapse of 24 hours, in other words, a polymer having a property in which the dissolution amount is less than 0.5 g.

Examples of the polymer that is insoluble in water and has fiber forming ability include, for example, completely saponified polyvinyl alcohol that can be subjected to an insoluble treatment after forming a film, partially saponified polyvinyl alcohol that can be subjected to a cross-linking treatment after forming a film by being used together with a cross-linking agent, oxazoline modified silicone, such as a poly(N-propanoyl ethylene imine) graft-dimethyl siloxane/γ-aminopropyl methyl siloxane copolymer, polyvinyl acetal diethyl aminoacetate, zein (a main component of corn protein), polyester, a polylactic acid (PLA), an acrylic resin, such as a polyacrylonitrile resin and a polymethacrylate resin, a polystyrene resin, a polyvinyl butyral resin, a polyethylene terephthalate resin, a polybutylene terephthalate resin, a polyurethane resin, a polyamide resin, a polyimide resin, and a polyamide imide resin. One kind selected from the water-insoluble polymers can be used, or two or more kinds can be used in combination. Among the water-insoluble polymers, it is preferable to use one kind or two or more kinds selected from the completely saponified polyvinyl alcohol that can be subjected to an insoluble treatment after forming a film, the partially saponified polyvinyl alcohol that can be subjected to a cross-linking treatment after forming a film by being used together with a cross-linking agent, the polyvinyl butyral resin, the polyurethane resin, the acrylic resin, such as a polymethacrylate resin, the polyvinyl acetal diethyl aminoacetate, the oxazoline modified silicone, such as a poly(N-propanoyl ethylene imine) graft-dimethyl siloxane/γ-aminopropyl methyl siloxane copolymer, the polylactic acid (PLA), and zein. Among the water-insoluble polymers, from the aspect of dispersibility to an alcohol solvent, the touch of the fiber, and the like, the partially saponified polyvinyl alcohol, the completely saponified polyvinyl alcohol, the polyvinyl butyral resin, the polymethacrylate resin, and the polyurethane resin are more preferred, and the partially saponified polyvinyl alcohol, the completely saponified polyvinyl alcohol, and the polyvinyl butyral resin are further preferred. From the aspect of being capable of stably and efficiently forming the film containing a fiber on the surface of the skin or the nail and from the aspect of durability of the film, forming properties of the film, and compatibility between followability with respect to the skin and the durability, the polyvinyl butyral resin is especially preferred.

An amount of the water-insoluble polymer for forming a fiber contained in the liquid composition is preferably 3 mass % or more, more preferably 4 mass % or more, and even more preferably 6 mass % or more. In addition, the contained amount is preferably 30 mass % or less, more preferably 25 mass % or less, and further preferably 20 mass % or less. The contained amount of the water-insoluble polymer for forming a fiber in the liquid composition is preferably 3 mass % or more and 30 mass % or less, further preferably 3 mass % or more and 25 mass % or less, and even more preferably 5 mass % or more and 20 mass % or less. By containing the water-insoluble polymer for forming a fiber in the liquid composition at this proportion, a fibrous film can be stably and efficiently formed.

The liquid composition may contain water. Since the water is ionized and charged compared to a solvent, such as ethanol, that is not ionized, or it dissolves ionic components to induce ionization, the water can impart conductivity to the liquid composition. Therefore, a fibrous film is stably formed on the surface of the skin or the nail by electrostatic spray. In addition, the water contributes to the improvement of the adhesiveness of a film to be formed by the electrostatic spray with respect to the skin or the nail, the improvement of the durability, and the appearance. From the aspect of obtaining the action effects, the water is preferably contained in the liquid composition at 0.2 mass % or more and 20 mass % or less, more preferably at 0.3 mass % or more and 15 mass % or less, and from the aspect of the forming properties of the fibrous film even in a humid environment, further preferably at 0.4 mass % or more and 10 mass % or less.

The liquid composition may further contain other components. Examples of the other components include, for example, polyols other than the above-described volatile liquid agents, oil that is liquid at 25° C., a plasticizer of the water-insoluble polymer for forming a fiber, an electroconductivity control agent of the liquid composition, a binder, a powder, such as a coloring pigment and an extender pigment, a colorant, a perfume, a repellent, an oxidant inhibitor, a stabilizer, an antiseptic agent, and various vitamins. In a case where the other components are contained in the liquid composition, a proportion of the other components contained is preferably 0.1 mass % or more and 30 mass % or less, and further preferably 0.5 mass % or more and 20 mass % or less.

A viscosity of the liquid composition at 25° C. is preferably 2 mPa·s or more and 3000 mPa·s or less, more preferably 10 mPa·s or more and 1500 mPa·s or less, further preferably 15 mPa·s or more and 1000 mPa·s or less, and even more preferably 15 mPa·s or more and 800 mPa·s or less, from the aspect of stably forming the fibrous film, from the aspect of spinnability at the time of performing the electrostatic spray, from the aspect of improving the durability of the film, and from the aspect of improving the touch of the film. The viscosity of the liquid composition is measured at 25° C. using an E-type viscosimeter. For example, an E-type viscosimeter (VISCONICEMD) manufactured by TOKYO KEIKI INC. can be used as the E-type viscosimeter. In that case, as measuring conditions, 25° C. is set, a cone-plate rotor No. 43 is used, and a suitable rotation speed according to the viscosity is selected as the number of rotations. The rotation speed is 5 rpm for the viscosity of 500 mPa·s or more, 10 rpm for the viscosity of 150 mPa·s or more and less than 500 mPa·s, and 20 rpm for the viscosity of less than 150 mPa·s.

As illustrated in FIG. 1 to FIG. 3, the electrostatic spraying main body 200 includes a housing 210 that internally contains each component, such as a power source unit 243 described later, and the housing 210 is configured such that the cartridge 100 is attachable and detachable.

The housing 210 is formed of an insulating material, that is, a material having a property of hardly conducting electricity. Note that, here, “insulating” or “hardly conducting electricity” indicates, for example, having volume resistivity (ASTM D257, JIS K6911) of greater than 10¹² Ωm. Examples of the insulating material used for the housing 210 include, for example, an insulating organic material, such as a synthetic resin, or an insulating inorganic material, such as glass or ceramic. As the insulating organic material, for example, polypropylene (PP), polyacetal, polyether ether ketone (PEEK), polytetrafluoroethylene (PTFE), monomer cast nylon, and the like can be used. On the other hand, a conductive material refers to a material having a property of easily conducting electricity, that is, a material having, for example, volume resistivity of less than or equal to 10⁻² Ωm.

### [Configuration of Cartridge]

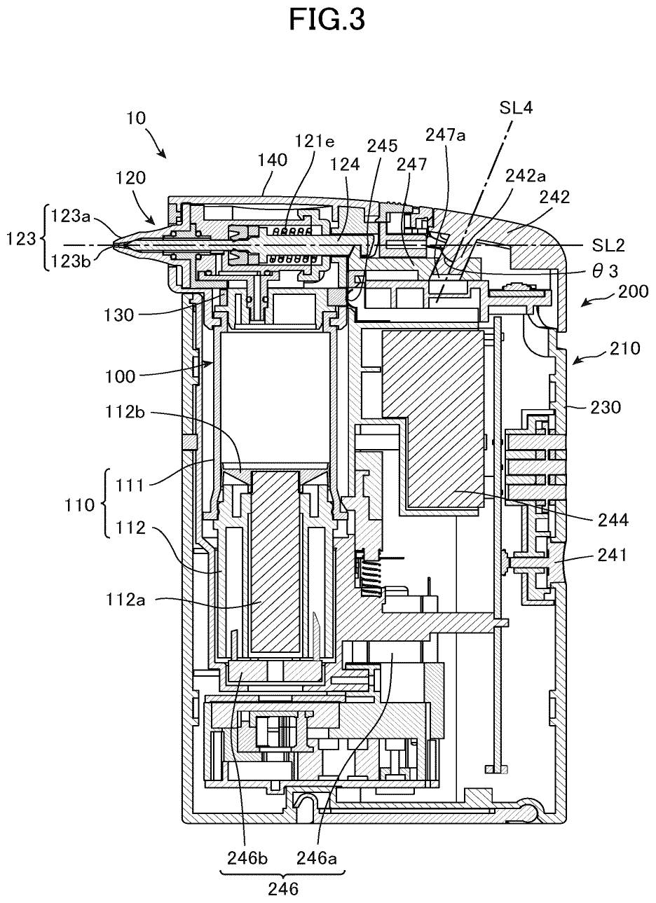

The cartridge 100 is a disposable container to be exchangeably mounted on a device that is a supply object of the liquid, and a use application thereof is not particularly limited. However, in the embodiment, the cartridge 100 is a cartridge for electrostatic spinning device that is used in an electrostatic spinning device. Specifically, as illustrated in FIG. 2 and FIG. 3, the cartridge 100 has a cylinder-type liquid containing portion 110 configured to contain the liquid composition, a spray unit 120 that is disposed on the liquid containing portion 110 and sprays the liquid composition in the liquid containing portion 110, a ring electrode 130 for supplying a voltage to a nozzle 123 described later of the spray unit 120, and a cover 140 that covers the liquid containing portion 110, the spray unit 120, and the ring electrode 130. The liquid containing portion 110, the spray unit 120, the ring electrode 130, and the cover 140 may be integrally formed or may be made of different members. In addition, the spray unit 120 or a part of the spray unit 120 may be in a disposable form similarly to the cartridge 100, or with only the liquid containing portion 110 being disposable, the spray unit 120 or a part of the spray unit 120 may be in a repeatedly usable form.

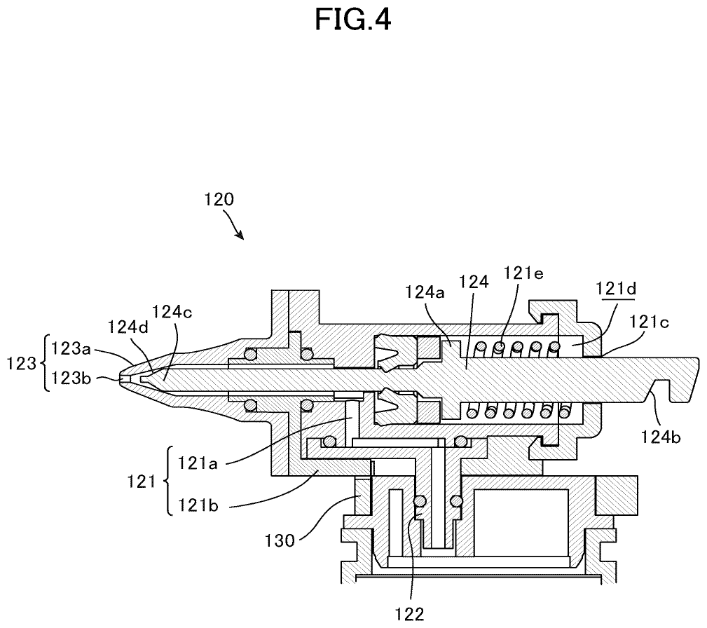

As illustrated in FIG. 3 and FIG. 4, the spray unit 120 has a mounting body 121, a connection body 122, the nozzle 123, and a shut-off pin 124. In the embodiment, a part of the mounting body 121 is formed of a conductive resin (for example, a resin containing carbon). Note that the “conductive resin” refers to a resin that contains a conductive material, such as metal or carbon, has low electric resistance, and easily allows electricity to flow, and for example, refers to a resin having volume resistivity of less than or equal to 10⁻² Ωm. As the resin, for example, a resin having solvent resistance against a solvent of ethanol and the like, such as a polypropylene (PP) resin, polyethylene terephthalate (PET), a polyethylene (PE) resin, and a polyacetal (POM) resin can be adopted. The entire mounting body 121, or the mounting body 121 and the connection body 122 may be constituted of a conductive resin.

The nozzle 123 and the shut-off pin 124 can be formed of an insulating resin. Note that the “insulating resin” refers to a general resin that does not contain a conductive material, such as metal or carbon, has high electric resistance, and hardly allows electricity to flow, and for example, refers to a resin having volume resistivity of greater than or equal to 10¹² Ωm. In the embodiment, the nozzle 123 and the shut-off pin 124 are formed of, for example, polypropylene (PP), polyethylene (PE), polyacetal, polyether ether ketone (PEEK), polytetrafluoroethylene (PTFE), and the like.

The mounting body 121 has a flow path 121a, a small electrode 121b, a through hole 121c, and a chamber 121d. The flow path 121a is a passage through which the liquid composition is distributed. The small electrode 121b is an electrode that electrostatically charges the liquid composition distributed inside the flow path 121a in an additional manner and is formed in an approximately cylindrical shape as a whole having an insertion hole through which the shut-off pin 124 is insertable. That is, the small electrode 121b is disposed so as to lie along an outer periphery of the shut-off pin 124 (so as to enclose the shut-off pin 124). The insertion hole of the small electrode 121b also functions as the flow path 121a. In addition, a part of the small electrode 121b is also disposed in the nozzle 123. That is, the small electrode 121b is disposed to extend from the mounting body 121 to the nozzle 123 inside the mounting body 121 and the nozzle 123. In the embodiment, the small electrode 121b is formed of a different member from the mounting body 121 and the nozzle 123 and fixed in the mounting body 121 and in the nozzle 123, but this should not be construed in a limiting sense. The small electrode 121b may be in a form of being integrally formed with the mounting body 121 and the nozzle 123.

The through hole 121c is formed on a rear side in a liquid spraying direction with respect to the nozzle 123 (right side of FIG. 4) and is configured to allow the shut-off pin 124 to be inserted through. Specifically, the through hole 121c is formed at an end portion on the rear side of the mounting body 121. The chamber 121d is configured to contain an engaging piece 124a of the shut-off pin 124 described later. In addition, a spring 121e having a winding so as to enclose the outer periphery of the shut-off pin 124 described later is provided inside the chamber 121d, and the spring 121e is configured to press the engaging piece 124a described later of the shut-off pin 124 described later toward the nozzle 123 side.

The connection body 122 is connected to the liquid containing portion 110 and communicated with the inside of the liquid containing portion 110, and is configured to guide the liquid composition in the liquid containing portion 110 to the flow path 121a of the mounting body 121. The nozzle 123 is connected to the mounting body 121, has a spray hole 123b at a tip of a nozzle tip portion 123a, and has a linear nozzle flow path that connects the spray hole 123b and the flow path 121a of the mounting body 121. That is, the connection between the flow path 121a of the mounting body 121 and the nozzle flow path functions as a single flow path that distributes the liquid composition to the spray hole 123b. The nozzle 123 is configured to spray the liquid composition in the liquid containing portion 110 with the spray hole 123b. In the embodiment, while the mounting body 121 is configured as a separate body from the connection body 122, the mounting body 121 and the connection body 122 may be integrally configured. In addition, while the nozzle 123 is configured as a separate body from the mounting body 121, the nozzle 123 and the mounting body 121 may be integrally configured.

Further, an inner diameter of a part of the nozzle 123 excluding the nozzle tip portion 123a and an inner diameter of the small electrode 121b are formed to be larger than an outer diameter of the shut-off pin 124. By thus forming the nozzle 123 and the small electrode 121b, the liquid composition can be distributed to a proximity of the spray hole 123b, and the liquid composition can be guided to the spray hole 123b only by slightly retracting the shut-off pin 124 described later from the spray hole 123b. In addition, since an inner surface of the part of the nozzle 123 excluding the nozzle tip portion 123a and an inner surface of the small electrode 121b do not come into contact with an outer surface of the shut-off pin 124, no friction is caused between the inner surfaces and the outer surface, allowing smoothly performing advancing and retracting movement, and the deterioration and breakage of the shut-off pin 124 due to friction can be avoided.

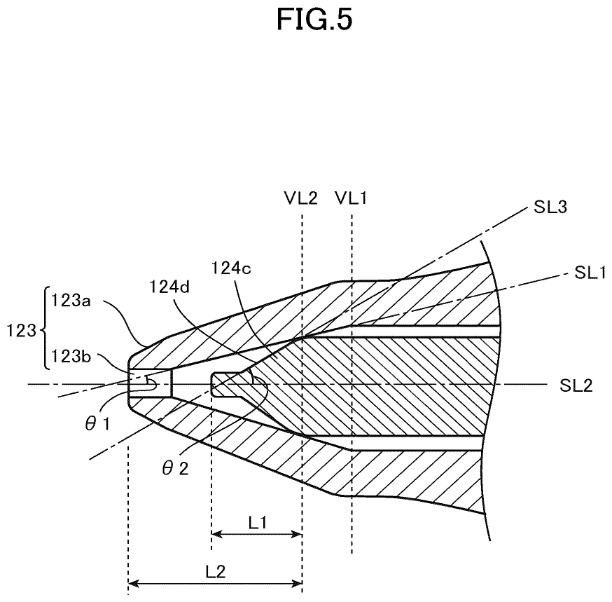

Here, as illustrated in FIG. 5, the nozzle tip portion 123a is a part located on the spray hole 123b side with a virtual line VL1 as a boundary. The virtual line VL1 passes vertically through a starting point at which the inner surface of the nozzle 123 parallel to an axial direction of the nozzle 123 is inclined toward the spray hole 123b. That is, the nozzle tip portion 123a has an inner diameter gradually decreasing toward the spray hole 123b and has a part in which the inner diameter of the nozzle tip portion 123a is smaller than the outer diameter of the shut-off pin 124. Note that the “axial direction of the nozzle 123” means an axis that passes through the center of the spray hole 123b of the nozzle 123 and lies along the liquid spraying direction.

Specifically, as illustrated in FIG. 5, in the nozzle tip portion 123a, on a cross-sectional surface along the axis of the nozzle 123, an angle θ1 formed by a straight line SL1 and a straight line SL2 is preferably 1° or more and 40° or less from the aspect of maintaining the sealability of the spray hole 123b and more preferably 5° or more and 35° or less from the aspect of reducing burden of the advancing and retracting movement of the shut-off pin 124. The straight line SL1 passes through both ends of an inner surface of the nozzle tip portion 123a (a starting point and an ending point of an inclined surface). The straight line SL2 extends along the axis of the nozzle 123 (the axis passing through the center of the spray hole 123b). In the embodiment, the inner surface of the nozzle tip portion 123a is a flat surface.

As illustrated in FIG. 3 or FIG. 4, the shut-off pin 124 is formed into a long rod shape that extends along the axial direction of the nozzle 123 and is held inside the spray unit 120. Specifically, the shut-off pin 124 is configured to be held inside the spray unit 120 by being supported by the through hole 121c, an inner wall of the mounting body 121 located between the chamber 121d and the small electrode 121b, and the nozzle tip portion 123a.

The shut-off pin 124 is configured to seal the spray hole 123b of the nozzle 123. Specifically, the shut-off pin 124 is configured to close the nozzle flow path of the nozzle 123 and seal the spray hole 123b of the nozzle 123 by coming into contact with (being locked to) the inner surface of the nozzle tip portion 123a of the nozzle 123.

In addition, the shut-off pin 124 includes the engaging piece 124a that comes in contact with the spring 121e provided in the chamber 121d in the vicinity of a center portion in the axial direction of the nozzle 123 and is configured to enhance the sealability of the spray hole 123b by transmitting a force to press the engaging piece 124a by the spring 121e through a shaft of the shut-off pin 124 to a tip portion 124c. In the embodiment, the engaging piece 124a is configured to function as a retainer of the shut-off pin 124 with respect to the mounting body 121 by engaging with an inner surface of the chamber 121d of the mounting body 121.

The engaging piece 124a is configured so as not to be in contact with the inner surface on the nozzle 123 side of the chamber 121d in a state where the shut-off pin 124 seals the spray hole 123b of the nozzle 123. This translates all the force to press the engaging piece 124a by the spring 121e into a force to press the inner surface of the nozzle tip portion 123a of the nozzle 123 by the shut-off pin 124, therefore allowing the spray hole 123b of the nozzle 123 to be efficiently sealed.

As illustrated in FIG. 3 and FIG. 4, a notch 124b that opens on the liquid containing portion 110 side (lower side of FIG. 3) is formed on a base end side of the shut-off pin 124 (opposite side to the liquid spraying direction), and the notch 124b is coupled to a coupling piece 247 described later in the electrostatic spraying main body 200.

In addition, the shut-off pin 124 is configured such that the tip portion 124c is unexposed from the spray hole 123b of the nozzle 123 in the state where the spray hole 123b is sealed. Specifically, the shut-off pin 124 is configured such that the tip portion 124c is unexposed from the spray hole 123b in a state of coming into contact with (being locked to) the inner surface of the nozzle tip portion 123a of the nozzle 123. Here, as illustrated in FIG. 5, the tip portion 124c is a part located on the spray hole 123b side with a virtual line VL2 as a boundary or a part that forms a flat surface along the virtual line VL2 in the state where the shut-off pin 124 comes in contact with (is locked to) the inner surface of the nozzle tip portion 123a of the nozzle 123. The virtual line VL2 passes vertically through contact points between the inner surface of the nozzle tip portion 123a and the shut-off pin 124. In the embodiment, the tip portion 124c is a part located on the spray hole 123b side with the virtual line VL2 as a boundary and is formed in an approximately conical shape tapering down from a base end of the tip portion 124c to a tip.

The shut-off pin 124 has a tip surface (tip surface of the tip portion 124c) formed in a flat shape or an obtuse angle shape. Here, the “flat shape” refers to a shape in which the tip surface of the shut-off pin 124 is flat, and the “obtuse angle shape” refers to a shape in which in the cross-sectional views along the axis of the nozzle 123 (FIG. 3 to FIG. 5), the tip surface of the shut-off pin 124 is formed at an obtuse angle. As illustrated in FIG. 3 to FIG. 5, in the embodiment, the tip surface of the shut-off pin 124 has a flat shape.

As illustrated in FIG. 4 and FIG. 5, the tip portion 124c is formed to have a length so as not to be exposed from the spray hole 123b of the nozzle 123 in the state where the shut-off pin 124 comes into contact with (is locked to) the inner surface of the nozzle tip portion 123a of the nozzle 123. Specifically, the tip portion 124c is configured such that a length L1 from the virtual line VL2 to a tip of the tip portion 124c (end portion on the spray hole 123b side) becomes shorter than a length L2 from the virtual line VL2 to the tip of the nozzle tip portion 123a. More specifically, the length L1 is preferably 20 mm or less and further preferably 10 mm or less from the aspect of avoiding the exposure of the tip of the tip portion 124c from the spray hole 123b, from the aspect of reducing a residual liquid in the nozzle flow path, and from the aspect of suppressing flow resistance of the nozzle flow path. In addition, from the aspect of sufficiently securing a length of a liquid sealing contact point, the length L1 is preferably 1 mm or more and further preferably 2 mm or more. The length L2 is preferably configured to be 2 mm or more and 30 mm or less and more preferably configured to be 3 mm or more and 20 mm or less.

Further, for the length L1, a difference obtained by subtracting the length L1 from the length L2 is preferably 0.5 mm or more from the aspect of avoiding the exposure of the tip of the tip portion 124c from the spray hole 123b, and further preferably 1 mm or more in consideration of runout caused by shaping and assembly. Moreover, from the aspect of reducing the residual liquid in the nozzle flow path, the length L1 is preferably 30% or more of the length L2 and further preferably 50% or more.

As illustrated in FIG. 5, the tip portion 124c is configured such that an angle θ2 formed by a straight line SL3 and the straight line SL2 is greater than the angle θ1 on the cross-sectional surface along the axis of the nozzle 123. The straight line SL3 passes through both ends of an outer surface of the tip portion 124c (a starting point and an ending point of an inclined surface 124d). Specifically, the angle θ2 is preferably 2° or more and 45° or less from the aspect of improving the sealability of the spray hole 123b, and more preferably 10° or more and 40° or less from the aspect of shortening a distance for which the shut-off pin 124 retracts and from the aspect of avoiding the exposure of the tip of the tip portion 124c from the spray hole 123b. In the embodiment, the inclined surface 124d is a flat surface.

The shut-off pin 124 is configured to be able to advance and retract in a flow path (in the flow path 121a and the nozzle flow path) along the axial direction of the nozzle 123 and configured to open and close the spray hole 123b of the nozzle 123. Specifically, the shut-off pin 124 is configured to move in conjunction with an operation manipulation unit 242 described later of the electrostatic spraying main body 200 at the rear with respect to the through hole 121c of the mounting body 121. More specifically, the shut-off pin 124 is connected to the operation manipulation unit 242 via the coupling piece 247 and configured such that, when the operation manipulation unit 242 is manipulated, the shut-off pin 124 retracts with respect to the tip of the nozzle 123 to open the spray hole 123b of the nozzle 123. In addition, the shut-off pin 124 is configured such that, when the manipulation of the operation manipulation unit 242 is completed, the shut-off pin 124 moves to the tip side of the nozzle 123 to seal the spray hole 123b of the nozzle 123.

As illustrated in FIG. 2 and FIG. 3, the liquid containing portion 110 has a cylinder shape including a first tubular member 111 that can be connected to the spray unit 120 and a second tubular member 112 that can be connected to the first tubular member 111 and has a smaller diameter than the first tubular member 111. The first tubular member 111 is a cylindrical container made of plastic and is configured to be able to contain the liquid composition.

The second tubular member 112 is a cylindrical container made of plastic and is configured to rotate relative to the first tubular member 111 by a rotational force generated by driving a driving unit 246 described later. Inside the second tubular member 112, a piston rod 112a and a piston 112b provided at an end portion on the spray unit 120 side of the piston rod 112a are disposed.

The piston rod 112a is configured to advance in the axial direction (a direction along the liquid containing portion 110) by the rotation of the second tubular member 112 and push up the piston 112b to the spray unit 120 side. Specifically, respective screws (not illustrated) that can mutually screw together are formed on an inner surface of the second tubular member 112 and an outer surface of the piston rod 112a, and the piston rod 112a is configured to screw forward to the spray unit 120 side by the rotation of the second tubular member 112. The piston 112b is configured to be able to advance and retract in the axial direction (the direction along the liquid containing portion 110) by the piston rod 112a and configured to be pushed up to the spray unit 120 side by the piston rod 112a to push the liquid composition out to the spray unit 120.

As illustrated in FIG. 3 and FIG. 4, the ring electrode 130 is disposed at an outer edge of an end portion on the spray unit 120 side of the liquid containing portion 110 and configured to be electrically connected to the small electrode 121b of the mounting body 121 on the nozzle 123 side and electrically connected to an output terminal 245 described later on an opposite side to the nozzle 123. That is, a voltage applied by the power source unit 243 described later is connected to the small electrode 121b of the mounting body 121 from the output terminal 245 described later via the ring electrode 130.

As illustrated in FIG. 1 to FIG. 3, the cover 140 is a cover that covers the end portion on the spray unit 120 side of the liquid containing portion 110, the mounting body 121 of the spray unit 120, the connection body 122, the shut-off pin 124, and the ring electrode 130. The cover 140 has openings at both end portions in a direction along the axis of the nozzle 123 and brings a state where the nozzle 123 projects out from one opening and the spray hole 123b is located outside the cover 140. From the other opening, the shut-off pin 124 can advance and retract along the axial direction of the nozzle 123. That is, the cover 140 is configured to allow the spray of the liquid composition from the spray unit 120 even in a case where the cover 140 is mounted on the liquid containing portion 110, the spray unit 120, and the ring electrode 130. In addition, the cover 140 can be formed of an insulating resin. In the embodiment, the cover 140 is formed of, for example, polypropylene (PP), polyethylene (PE), polyacetal, polyether ether ketone (PEEK), polytetrafluoroethylene (PTFE), and the like.

### [External Structure of Housing]

As illustrated in FIG. 1 and FIG. 2, the housing 210 includes a containing space 220 that contains the liquid containing portion 110, an insertion hole 221 for inserting the liquid containing portion 110 into the containing space 220, a grip portion 230 configured to be gripped by a user, a main power source manipulation unit 241 that turns ON/OFF power supply from the power source unit 243, and the operation manipulation unit 242 manipulated for spraying the liquid composition. The housing 210 has a shape and a size that can be gripped by the user with one hand as a whole. Specifically, the housing 210 is formed in a box shape (tubular shape having an upper surface and a lower surface) having an internal space in which the containing space 220 and a space for containing respective components, such as the power source unit 243, are separated from one another and has a cross-sectional surface perpendicular to an axial direction (a first direction and an up-down direction in FIG. 3) having an elliptical shape that has a long axis and a short axis. In addition, the housing 210 has a length in the direction along the axis of the nozzle 123 of, for example, 4 cm or more and 11 cm or less.

As illustrated in FIG. 2, in the direction along the axis of the nozzle 123, on one end portion side of the housing 210 (an upper end portion side in FIG. 2), the insertion hole 221, through which the liquid containing portion 110 is insertable, is formed, and the containing space 220, which is communicated with the insertion hole 221 and contains the liquid containing portion 110, is formed. The insertion hole 221 and the containing space 220 are formed into a shape and a size that allows the liquid containing portion 110 to be inserted and removed.

The containing space 220 is formed along the axial direction of the housing 210 and is an opening space opening upward, which is formed by an inner wall of the housing 210 and a gear 246b of the driving unit 246 described later. Therefore, the liquid containing portion 110 is inserted into the containing space 220 downward (the liquid containing portion 110 side) from above (the spray unit 120 side).

As illustrated in FIG. 2 and FIG. 3, the grip portion 230, the main power source manipulation unit 241, and the operation manipulation unit 242 are disposed on the other end portion side of the housing 210. Specifically, the grip portion 230, the main power source manipulation unit 241, and the operation manipulation unit 242 are disposed on the rear side in the liquid spraying direction with respect to the nozzle 123. The main power source manipulation unit 241 and the operation manipulation unit 242 are attached in a state where they can be manipulated from the outside of the housing 210. Specifically, the operation manipulation unit 242 is disposed at a corner portion at which an upper surface and a rear surface (surface on the rear side in the liquid spraying direction) of the housing 210 intersect, and the main power source manipulation unit 241 is disposed on the rear surface of the housing 210. In addition, the grip portion 230 is disposed on the lower side of the electrostatic spraying main body 200 with respect to the operation manipulation unit 242. The grip portion 230 is formed in a shape and a size that are allowed to be gripped by a user with one hand, and the power source unit 243 described later, a high-voltage generating unit 244, the output terminal 245, a motor 246a of the driving unit 246, and the coupling piece 247 are disposed inside the grip portion 230.

### [Internal Structure and Operation of Housing]

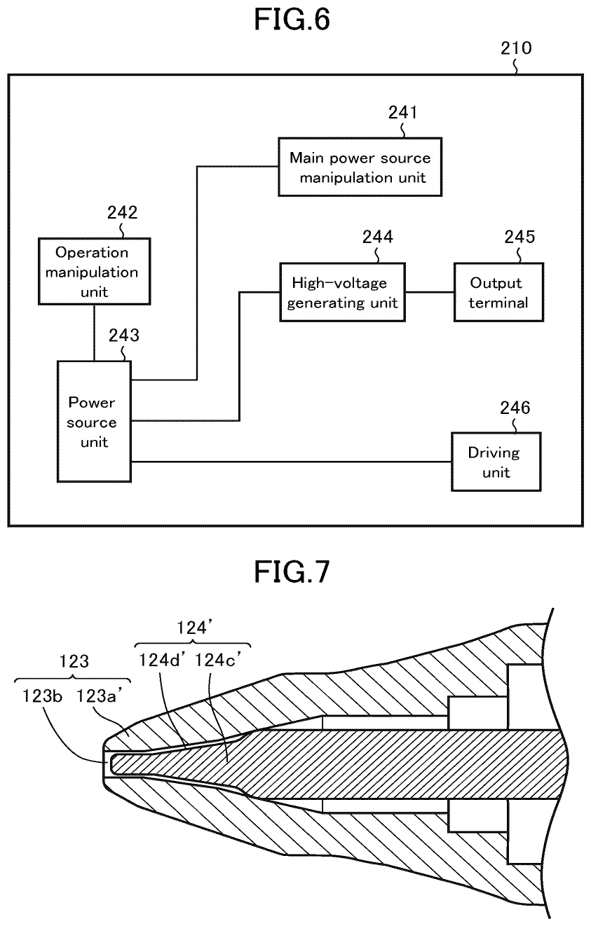

Next, the internal structure of the housing 210 will be described by referring to FIG. 3 and FIG. 6. The power source unit 243, the high-voltage generating unit 244, the output terminal 245, the driving unit 246, and the coupling piece 247 are provided in the housing 210.

As illustrated in FIG. 3, the driving unit 246 includes the motor 246a that generates a rotational force and the gear 246b that transmits the rotation output from the motor 246a to the second tubular member 112. The motor 246a is a motor for pushing out the liquid composition contained in the liquid containing portion 110 upward (the nozzle 123 side) and generates a rotational force when power is supplied by the power source unit 243. The gear 246b is mechanically coupled to the second tubular member 112 under the liquid containing portion 110 (the opposite side to the nozzle 123) and is configured to transmit the rotational force generated by the motor 246a to the second tubular member 112 to rotate the second tubular member 112.

As illustrated in FIG. 3, the coupling piece 247 is a piece that extends along the axial direction of the nozzle 123 and has a projecting piece projecting upward (upper side in FIG. 3) formed at an end portion on the nozzle 123 side. The coupling piece 247 is configured such that the notch 124b of the shut-off pin 124 engages with the projecting piece of the coupling piece 247 when the liquid containing portion 110 is inserted into the containing space 220 downward from above. That is, the coupling piece 247 is configured to be located on the lower side with respect to the shut-off pin 124 in the state where the liquid containing portion 110 is inserted into the containing space 220. Note that the coupling piece 247 may be in a form of being located on the upper side with respect to the shut-off pin 124.

In addition, as illustrated in FIG. 3, the coupling piece 247 has an insertion portion 247a, through which a projecting portion 242a is insertable, formed at an end portion on the opposite side to the nozzle 123. The projecting portion 242a is provided inside the operation manipulation unit 242. The insertion portion 247a and the projecting portion 242a have a shape that is inclined to the nozzle 123 side with respect to a vertical direction perpendicular to the axial direction of the nozzle 123, that is, the axial direction of the housing 210 (up-down direction in FIG. 3). The insertion portion 247a and the projecting portion 242a are configured such that the projecting portion 242a moves along an inclined surface of the insertion portion 247a along the axial direction of the housing 210 when the operation manipulation unit 242 is pushed to an inward direction from the outside, thereby causing the coupling piece 247 to move backward (an opposite direction to the liquid spraying direction).

Specifically, the insertion portion 247a and the projecting portion 242a have an inclination angle, that is, an angle θ3 formed by the straight line SL2 and a straight line SL4 of preferably 45° or more and more preferably 60° or more from the aspect of suppressing a pulling force with a simple configuration in a compact device. The straight line SL4 passes through an axis of the insertion portion 247a and the projecting portion 242a. In addition, the shut-off pin 124 needs to be moved long in a front-back direction so that the liquid composition is allowed to flow through the nozzle flow path when the shut-off pin 124 performs the retracting movement. Therefore, in the insertion portion 247a and the projecting portion 242a, the angle θ3 formed by the straight line SL2 and the straight line SL4 is preferably 80° or less and more preferably 75° or less.

Then, when the coupling piece 247 moves backward, the shut-off pin 124 retracts in conjunction with the movement of the coupling piece 247. The insertion portion 247a may be a through hole through which the projecting portion 242a is allowed to penetrate or may be a recessed surface that can hold the projecting portion 242a.

Next, an operation performed by manipulating the main power source manipulation unit 241 and the operation manipulation unit 242 will be described. When the cartridge 100 is contained in the containing space 220 of the housing 210, the output terminal 245 is electrically connected to the small electrode 121b included inside the mounting body 121 of the cartridge 100 via the ring electrode 130 provided in the cartridge 100. In addition, the gear 246b of the driving unit 246 is mechanically coupled to the second tubular member 112 included in the cartridge 100.

When the main power source manipulation unit 241 is kept off (OFF), the power is not supplied to the high-voltage generating unit 244 or the driving unit 246 from the power source unit 243. In view of this, a high voltage is not generated from the high-voltage generating unit 244, or the driving unit 246 is not driven. Therefore, as long as the main power source manipulation unit 241 is kept OFF, the liquid composition contained in the liquid containing portion 110 is not electrostatically charged and the liquid composition is not sprayed even when a user mistakenly manipulates the operation manipulation unit 242.

The operation manipulation unit 242 is constituted of, for example, a switch that can switch between an on (ON) state and an off (OFF) state.

When the operation manipulation unit 242 is turned ON while the main power source manipulation unit 241 is in the ON state, the power is supplied to the high-voltage generating unit 244 and the driving unit 246 from the power source unit 243. Then, the motor 246a of the driving unit 246 is driven to generate a rotational force, and the rotational force is transmitted to the second tubular member 112 included in the cartridge 100 via the gear 246b of the driving unit 246 to rotate the second tubular member 112. The rotation of the second tubular member 112 causes the piston rod 112a that screws with the inner surface of the second tubular member 112 to screw forward to the spray unit 120 side to push up the piston 112b to the spray unit 120 side and push out the liquid composition in the first tubular member 111 to the spray unit 120 side. The high-voltage generating unit 244 generates a positive high voltage (for example, several kV to several dozen kV) and sends the generated high voltage to the output terminal 245. The output terminal 245 sends the high voltage to the small electrode 121b included in the cartridge 100 via the ring electrode 130 provided in the cartridge 100. The small electrode 121b electrostatically charges the liquid composition distributed inside the cartridge 100 by the application of the high voltage.

When the liquid composition that is electrostatically charged as described above flows into the spray unit 120 from the liquid containing portion 110 and reaches the nozzle 123, the liquid composition is sprayed toward an object from the spray hole 123b of the nozzle 123 by the electrostatic force based on the potential difference between the electrically charged liquid composition and the object. Afterwards, when the operation manipulation unit 242 is turned OFF, the spray of the liquid composition is stopped.

In the housing 210, a selector switch (not illustrated) that can adjust a sprayed amount of the liquid composition in multiple stages (for example, two stages of large/small) or a switch for causing the liquid composition to reach the nozzle 123 without generating a high voltage may be provided in addition to the main power source manipulation unit 241 and the operation manipulation unit 242.

### Advantages of Electrostatic Spraying Device According to the Embodiment

Thus, the electrostatic spraying device 10 according to the embodiment is the electrostatic spraying device 10 that includes the spray unit 120 that sprays a liquid. The spray unit 120 includes the nozzle 123 for spraying the liquid, the flow path for distributing the liquid to the spray hole 123b provided at the nozzle tip portion 123a, and the shut-off pin 124 configured to advance and retract in the flow path and configured to seal the spray hole 123b. The shut-off pin 124 has the tip portion 124c that is unexposed from the spray hole 123b in a state where the spray hole 123b is sealed.

With the electrostatic spraying device 10 having the configuration, since the spray hole 123b of the nozzle 123 is sealed by the shut-off pin 124, situations of dripping and the liquid composition sticking in the nozzle 123 can be avoided. In addition, since the tip portion 124c of the shut-off pin 124 is unexposed from the spray hole 123b of the nozzle 123, a situation in which a user gets injured by coming into contact with the shut-off pin 124 can be avoided. Accordingly, the electrostatic spraying device 10 has the remarkable advantage that the user can safely use the electrostatic spraying device 10 and the advantage of being able to avoid a risk of damaging the tip of the shut-off pin 124 due to unintended contact and a risk of the shut-off pin 124 being pushed from the tip to reduce liquid seal performance.

In addition, the electrostatic spraying device 10 according to the embodiment includes the cartridge 100 having the liquid containing portion 110 that contains the liquid and the spray unit 120 and the electrostatic spraying main body 200 into and from which the liquid containing portion 110 of the cartridge 100 is insertable and removable. With the electrostatic spraying device 10 having the configuration, since the liquid containing portion 110 and the spray unit 120 are provided in the cartridge 100, the cartridge 100 can be easily attached to and detached from the electrostatic spraying main body 200.

Furthermore, in the electrostatic spraying device 10 according to the embodiment, the nozzle tip portion 123a has a part having an inner diameter smaller than the outer diameter of the shut-off pin 124, and the shut-off pin 124 is configured to seal the spray hole 123b by being locked to the inner surface of the nozzle tip portion 123a. The electrostatic spraying device 10 having the configuration can ensure that the spray hole 123b of the nozzle 123 is sealed, therefore having the advantage that the situations of dripping and the liquid composition sticking in the nozzle 123 can be easily avoided.

Furthermore, in the electrostatic spraying device 10 according to the embodiment, the nozzle 123 and the shut-off pin 124 are constituted of an insulating resin. The electrostatic spraying device 10 having the configuration can avoid accidents and discomfort due to electric shock because the nozzle 123 and the shut-off pin 124 are constituted of an insulating resin, therefore having the advantage of allowing the user to safely use the electrostatic spraying device 10.

In addition, in the electrostatic spraying device 10 according to the embodiment, the tip surface of the shut-off pin 124 has a flat or obtuse angle shape. The electrostatic spraying device 10 having the configuration can avoid injuries caused by the user coming into contact with the tip portion 124c of the shut-off pin 124 even if the shut-off pin 124 is exposed from the spray hole 123b of the nozzle 123, therefore having the advantage of allowing the user to safely use the electrostatic spraying device 10.

Furthermore, the electrostatic spraying device 10 according to the embodiment has an electrode (small electrode 121b) disposed along the outer periphery of the shut-off pin 124 in the nozzle 123, and the electrode (small electrode 121b) is fixed in the nozzle 123. The electrostatic spraying device 10 having the configuration enables the liquid to be electrostatically charged at a position close to the spray hole 123b of the nozzle 123, therefore having the advantage that spraying efficiency of the liquid, for example, spinning performance can be improved.

In the electrostatic spraying device 10 according to the embodiment, the spray unit 120 has the through hole 121c through which the shut-off pin 124 is insertable on the rear side in the liquid spraying direction with respect to the nozzle 123. In addition, the electrostatic spraying device 10 according to the embodiment includes the operation manipulation unit 242 for controlling the spray operation of the liquid, and the shut-off pin 124 is configured to move in conjunction with the operation manipulation unit 242 at the rear with respect to the through hole 121c. The electrostatic spraying device 10 having the configuration has the advantage that the advancing and retracting movement of the shut-off pin 124 can be guided by the through hole 121c and moving in conjunction with the operation manipulation unit 242 allows performing on/off of a switch and opening/closing of the spray hole 123b with a single manipulation.

Furthermore, in the electrostatic spraying device 10 according to the embodiment, on the cross-sectional surface along the axis of the nozzle 123, the angle θ1 formed by the straight line SL1 passing through both ends of the inner surface of the nozzle tip portion 123a and the straight line SL2 extending along the axis of the nozzle 123 is 1° or more and 40° or less. The electrostatic spraying device 10 having the configuration has the advantage that the sealability of the spray hole 123b can be improved and the distance for which the shut-off pin 124 retracts can be shortened.

### [Modification]

The electrostatic spraying device according to the present invention is not limited to the embodiment described above, and various modifications can be made within the scope that does not deviate from the technical idea of the present invention.

For example, in the above-described embodiment, the inclined surface 124d of the tip portion 124c of the shut-off pin 124 has been described as being a flat surface, but is not limited to this. For example, as illustrated in FIG. 7, at a tip portion 124c′ formed in an approximately conical shape tapering down from a base end to a tip, an inclined surface 124d′ may have a configuration in which the tip side with respect to a contact point between an outer surface of a shut-off pin 124′ and an inner surface of a nozzle tip portion 123a′ is formed to be recessed inward in a radial direction and a step is formed from a starting point to an ending point of the inclined surface 124d′. This generates a gap between the inner surface of the nozzle tip portion 123a′ and the inclined surface 124d′ formed to be partially recessed inward even though the tip portion 124c′ has a longer length L1 than the embodiment described above, therefore allowing a nozzle flow path to be secured when the shut-off pin 124′ performs the retracting movement. Note that in FIG. 7, the common configurations with the above-described embodiment are indicated by the same reference numerals.

In addition, in the above-described embodiment, the inner surface of the nozzle tip portion 123a has been described as being a flat surface, but this should not be construed in a limiting sense. As illustrated in FIG. 7, the inner surface of the nozzle tip portion 123a′ may be formed to bulge to the shut-off pin 124′ side.

Furthermore, in the above-described embodiment, it has been described that the nozzle tip portion 123a has a part having an inner diameter smaller than the outer diameter of the shut-off pin 124 and the shut-off pin 124 is configured to seal the spray hole 123b by being locked to the inner surface of the nozzle tip portion 123a, but this should not be construed in a limiting sense. For example, the inner surface of the nozzle 123 and the outer diameter of the shut-off pin 124 may be formed to have approximately the same size, thereby configuring to seal the spray hole 123b.

Moreover, in the above-described embodiment, the tip surface of the shut-off pin 124 has been described as having a flat or obtuse angle shape, but this should not be construed in a limiting sense. For example, it is only necessary for the tip surface of the shut-off pin 124 to have a shape that allows a user to avoid injuries caused by coming into contact with the tip portion 124c.

Furthermore, in the above-described embodiment, the small electrode 121b has been described as being disposed along the outer periphery of the shut-off pin 124, but this should not be construed in a limiting sense. For example, the small electrode 121b may be configured to be disposed only on the ring electrode 130 side.

In addition, in the above-described embodiment, the shut-off pin 124 has been described as moving in conjunction with the operation manipulation unit 242 at the rear with respect to the through hole 121c, but this should not be construed in a limiting sense. For example, the shut-off pin 124 may be configured so as not to move in conjunction with an operation manipulation unit and a switch for opening and closing the spray hole 123b may be separately provided.

Furthermore, in the above-described embodiment, the cartridge for electrostatic spraying device 100 has been described as being configured to be insertable and removable with respect to the electrostatic spraying main body 200, but this should not be construed in a limiting sense. For example, the cartridge for electrostatic spraying device 100 may be configured such that the spray unit 120, the ring electrode 130, and the cover 140 of the cartridge 100 are fixed to the electrostatic spraying main body 200 and only the liquid containing portion 110 containing the liquid composition is attachable and detachable with respect to the electrostatic spraying main body 200.

Moreover, in the above-described embodiment, it has been described that the output terminal 245 is electrically connected to the small electrode 121b via the ring electrode 130, and the small electrode 121b electrostatically charges the liquid composition distributed inside the cartridge 100 by supplying a high voltage from the high-voltage generating unit 244 to the small electrode 121b via the output terminal 245 and the ring electrode 130. This, however, should not be construed in a limiting sense. For example, the mounting body 121 of the spray unit 120 may be configured as an electrode (integrated electrode configured as an integral body) that can be electrically connected to the output terminal 245, and the mounting body 121 may be configured to electrostatically charge the liquid composition distributed inside the cartridge 100 by supplying a high voltage from the high-voltage generating unit 244 to the mounting body 121 as an electrode via the output terminal 245. In this case, the mounting body 121 preferably has a part disposed along the outer periphery of the shut-off pin 124 and is preferably fixed in the nozzle 123. The mounting body 121 being thus configured as an electrode that can be electrically connected to the output terminal 245 has the advantage that the number of components can be reduced compared to the case of including the small electrode 121b and the ring electrode 130.

It is apparent from the description of the claims that the modifications as described above are included in the scope of the present invention.

Regarding the above-described embodiment, the present invention further discloses the following electrostatic spraying device and cartridge for electrostatic spraying device.

<1>

An electrostatic spraying device including a spray unit that sprays a liquid,
in which the spray unit includes a nozzle for spraying the liquid, a flow path for distributing the liquid to a spray hole provided at a nozzle tip portion, and a shut-off pin configured to advance and retract in the flow path and configured to seal the spray hole, and
the shut-off pin has a tip portion that is unexposed from the spray hole in a state where the spray hole is sealed.

<2>

The electrostatic spraying device according to <1>, including:
a cartridge having a liquid containing portion that contains the liquid and the spray unit; and
an electrostatic spraying main body into and from which the liquid containing portion of the cartridge is insertable and removable.

<3>

The electrostatic spraying device according to <2>,
in which the electrostatic spraying main body includes a containing space configured to house the liquid containing portion of the cartridge and a tubular housing internally having the containing space, and
the housing has a shape and a size configured to be gripped by a user with one hand.

<4>

The electrostatic spraying device according to <3>,
in which the housing has a cross-sectional surface perpendicular to an axial direction of the housing having an elliptical shape that has a long axis and a short axis.

<5>

The electrostatic spraying device according to any one of <1> to <4>,
in which the nozzle tip portion has a part having an inner diameter smaller than an outer diameter of the shut-off pin, and
the shut-off pin is configured to seal the spray hole by being locked to an inner surface of the nozzle tip portion.

<6>

The electrostatic spraying device according to <5>,
in which, in a state where the shut-off pin is locked to the inner surface of the nozzle tip portion, a length from a virtual line, which passes vertically through a contact point between the inner surface of the nozzle tip portion and the shut-off pin, to a tip of the tip portion of the shut-off pin is configured to be shorter than a length from the virtual line to the tip of the nozzle tip portion.

<7>

The electrostatic spraying device according to <6>,
in which a difference obtained by subtracting the length from the virtual line to the tip of the tip portion of the shut-off pin from the length from the virtual line to the tip of the nozzle tip portion is 0.5 mm or more.

<8>

The electrostatic spraying device according to <6> or <7>,
in which the length from the virtual line to the tip of the tip portion of the shut-off pin is 30% or more of the length from the virtual line to the tip of the nozzle tip portion.

<9>

The electrostatic spraying device according to any one of <6> to <8>,
in which the length from the virtual line to the tip of the tip portion of the shut-off pin is 1 mm or more and 20 mm or less, and
the length from the virtual line to the tip of the nozzle tip portion is 2 mm or more and 30 mm or less.

<10>

The electrostatic spraying device according to any one of <1> to <9>,
in which the nozzle and the shut-off pin are constituted of an insulating resin.

<11>

The electrostatic spraying device according to any one of <1> to <10>, in which a tip surface of the shut-off pin has a flat or obtuse angle shape.

<12>

The electrostatic spraying device according to any one of <1> to <11>, including
an electrode disposed along an outer periphery of the shut-off pin in the nozzle,
in which the electrode is fixed in the nozzle.

<13>

The electrostatic spraying device according to any one of <1> to <12>,
in which the spray unit has a through hole through which the shut-off pin is insertable on a rear side in a liquid spraying direction with respect to the nozzle.

<14>

The electrostatic spraying device according to <13>, including
an operation manipulation unit for controlling spray operation of the liquid,
in which the shut-off pin moves in conjunction with the operation manipulation unit at a rear with respect to the through hole.

<15>

The electrostatic spraying device according to <14>,
in which the shut-off pin is configured to retract with respect to the tip of the nozzle when the operation manipulation unit is manipulated, and move to the tip side of the nozzle when the manipulation of the operation manipulation unit is completed.

<16>

The electrostatic spraying device according to <14> or <15>, including
a coupling piece formed to extend along an axial direction of the nozzle and connected to the shut-off pin and the operation manipulation unit,
in which the shut-off pin has a notch formed on a base end side of the shut-off pin,
the operation manipulation unit has a projecting portion provided to project toward an inside of the operation manipulation unit, and
the coupling piece has:
   a projecting piece provided at an end portion on the nozzle side and engaging with the notch of the shut-off pin; and
   an insertion portion provided at an end portion on an opposite side of the nozzle, the insertion portion through which the projecting portion of the operation manipulation unit is insertable.

<17>

The electrostatic spraying device according to <16>,
in which the projecting portion of the operation manipulation unit and the insertion portion of the coupling piece have a shape that is inclined to the nozzle side with respect to a vertical direction perpendicular to the axial direction of the nozzle.

<18>

The electrostatic spraying device according to <17>,
in which, in the projecting portion of the operation manipulation unit and the insertion portion of the coupling piece, an angle θ formed by a straight line extending along an axis of the nozzle and a straight line passing through an axis of the projecting portion and the coupling piece is 45° or more and 80° or less.

<19>

The electrostatic spraying device according to <18>,
in which on a cross-sectional surface along the axis of the nozzle, an angle θ formed by a straight line passing through both ends of an inner surface of the nozzle tip portion and the straight line extending along the axis of the nozzle is 1° or more and 40° or less.

<20>

The electrostatic spraying device according to <19>,
in which on the cross-sectional surface along the axis of the nozzle, an angle θ formed by a straight line passing through both ends of an outer surface of the tip portion of the shut-off pin and the straight line extending along the axis of the nozzle is configured to be larger than the angle θ formed by the straight line passing through both ends of the inner surface of the nozzle tip portion and the straight line extending along the axis of the nozzle.

<21>

The electrostatic spraying device according to <20>,
in which on the cross-sectional surface along the axis of the nozzle, the angle θ formed by the straight line passing through both ends of the outer surface of the tip portion of the shut-off pin and the straight line extending along the axis of the nozzle is 2° or more and 45° or less.

<22>

The electrostatic spraying device according to any one of <1> to <21>,
in which the spray unit has a chamber formed on the rear side in the liquid spraying direction with respect to the nozzle,
the shut-off pin has an engaging piece housed in the chamber, and
the engaging piece engages with an inner surface on an opposite side to the nozzle side of the chamber.

<23>

The electrostatic spraying device according to <22>,
in which the engaging piece is configured so as not to be in contact with the inner surface on the nozzle side of the chamber in a state where the shut-off pin seals the spray hole.

<24>

The electrostatic spraying device according to <22> or <23>,
in which a spring enclosing an outer periphery of the shut-off pin is provided inside the chamber, and
the spring is configured to press the engaging piece toward the nozzle side.

<25>

The electrostatic spraying device according to any one of <1> to <24>,
in which the flow path is configured to have an inner diameter larger than the outer diameter of the shut-off pin.

<26>

The electrostatic spraying device according to any one of <1> to <25>,
in which the liquid contains a volatile substance, a water-insoluble polymer for forming a fiber, and water and forms a film as a deposit containing a fiber on a surface of skin of a user.

<27>

A cartridge for electrostatic spraying device including a spray unit that sprays a liquid,
in which the spray unit includes a nozzle for spraying the liquid, a flow path for distributing the liquid to a spray hole provided at a nozzle tip portion, and a shut-off pin configured to advance and retract in the flow path and configured to seal the spray hole, and
the shut-off pin has a tip portion that is unexposed from the spray hole in a state where the spray hole is sealed.

### DESCRIPTION OF REFERENCE NUMERAL

10 Electrostatic spraying device
100 Cartridge for electrostatic spraying device
110 Liquid containing portion
111 First tubular member
112 Second tubular member
112a Piston rod
112b Piston
120 Spray unit
121 Mounting body
121a Flow path
121b Small electrode
121c Through hole
121d Chamber
121e Screw
122 Connection body
123 Nozzle
123a Nozzle tip portion
123b Spray hole
124 Shut-off pin
124a Engaging piece
124b Notch
124c Tip portion
124d Inclined surface
130 Ring electrode
140 Cover
200 Electrostatic spraying main body
210 Housing
220 Containing space
221 Insertion hole
230 Grip portion
241 Main power source manipulation unit
242 Operation manipulation unit
242a Projecting portion
243 Power source unit
244 High-voltage generating unit
245 Output terminal
246 Driving unit
246a Motor
246b Gear
247 Coupling piece
247a Insertion portion

1. An electrostatic spraying device, comprising:
a spray unit that sprays a liquid,
wherein the spray unit comprises:
a nozzle for spraying the liquid;
a flow path for distributing the liquid to a spray hole provided at a nozzle tip portion; and
a shut-off pin configured to advance and retract in the flow path and configured to seal the spray hole, and
wherein the shut-off pin has a tip portion that is unexposed from the spray hole in a state where the spray hole is sealed.

2. The electrostatic spraying device of claim 1, further comprising:
a cartridge having a liquid containing portion that contains the liquid and the spray unit; and
an electrostatic spraying main body into and from which the liquid containing portion of the cartridge is insertable and removable.

3. The electrostatic spraying device of claim 1, wherein:
the nozzle tip portion has a part having an inner diameter smaller than an outer diameter of the shut-off pin, and
the shut-off pin is configured to seal the spray hole by being locked to an inner surface of the nozzle tip portion.

4. The electrostatic spraying device of claim 1, wherein the nozzle and the shut-off pin are constituted of an insulating resin.

5. The electrostatic spraying device of claim 1, wherein a tip surface of the shut-off pin has a flat or obtuse angle shape.

6. The electrostatic spraying device of claim 1, further comprising:
an electrode disposed along an outer periphery of the shut-off pin in the nozzle,
wherein the electrode is fixed in the nozzle.

7. The electrostatic spraying device of claim 1, wherein the spray unit has a through hole through which the shut-off pin is insertable on a rear side in a liquid spraying direction with respect to the nozzle.

8. The electrostatic spraying device of claim 7, further comprising:
an operation manipulation unit for controlling spray operation of the liquid,
wherein the shut-off pin moves in conjunction with the operation manipulation unit at a rear with respect to the through hole.

9. The electrostatic spraying device of claim 1, wherein on a cross-sectional surface along an axis of the nozzle, an angle θ formed by a straight line passing through both ends of an inner surface of the nozzle tip portion and a straight line extending along the axis of the nozzle is 1° to 40°.

10. A cartridge for an electrostatic spraying device including a spray unit that sprays a liquid,
wherein the spray unit comprises:
a nozzle for spraying the liquid;
a flow path for distributing the liquid to a spray hole provided at a nozzle tip portion; and
a shut-off pin configured to advance and retract in the flow path and configured to seal the spray hole, and
wherein the shut-off pin has a tip portion that is unexposed from the spray hole in a state where the spray hole is sealed.
